(19) United States
(12) Patent Application Publication
(10) Pub. No.: US 2013/0044735 A1
(43) Pub. Date: Feb. 21, 2013

(54) WIRELESS LOCAL AREA NETWORK ACCESS POINT SYSTEM BASED ON VIRTUAL ACCESS POINT SERVICE

(71) Applicants: Meong Hun LEE, Daejeon-si (KR); Yoon Ju LEE, Daejeon-si (KR); Kwang Jae LIM, Daejeon-si (KR); Dong Seung KWON, Daejeon-si (KR); Sung Hoon KIM, Daejeon-si (KR)

(72) Inventors: Meong Hun LEE, Daejeon-si (KR); Yoon Ju LEE, Daejeon-si (KR); Kwang Jae LIM, Daejeon-si (KR); Dong Seung KWON, Daejeon-si (KR); Sung Hoon KIM, Daejeon-si (KR)

(73) Assignee: ELECTRONICS AND TELECOMMUNICATIONS RESEARCH INSTITUTE, Daejeon-si (KR)

(21) Appl. No.: 13/528,351

(22) Filed: Jun. 20, 2012

(30) Foreign Application Priority Data
Aug. 18, 2011 (KR) 10-2011-0082075

(51) Int. Cl. H04W 72/04; H04W 84/12

(52) U.S. Cl. 370/336; 370/329

(57) ABSTRACT

A wireless local area network (WLAN) access point (AP) system is provided. The WLAN AP system includes a first virtual access point (VAP) that is logical entity performing communication with a first station (STA); and a second VAP performing communication with a second STA. The first VAP uses a first channel to exchange a frame with the first STA and the second VAP uses a second channel to exchange a frame with the second STA.

### CROSS-REFERENCE TO RELATED APPLICATIONS

This application claims the benefit of priority of Korean Patent Application No. 10-2011-0082075 filed on Aug. 18, 2011, which is incorporated by reference in their entirety herein.

### BACKGROUND OF THE INVENTION

1. Field of the invention

The present invention relates to a wireless local area network system, and more particularly, to a WLAN access point (AP) system based on a virtual access point service and a frame transmitting method for the same.

2. Related Art

Recently, various wireless communication technologies have been developed with advancement of information communication technologies. Among others, a wireless local area network (WLAN) is a technology of wirelessly accessing the Internet in home, business, or specific service providing areas by using mobile terminals such as a personal digital assistant (PDA), a lap top computer, a portable multimedia player (PMP), or the like, based on a wireless frequency technology.

The WLAN system has been focused as a wireless communication technology providing a fast data service in an unlicensed band. In particular, unlike the existing cellular communication system, an access point (AP) serving as a base station can be easily installed by anybody when it is connected with a wired network including a distribution system and a power supply and is connected with a wired network and it is an inexpensive means to implement data communication. As a result, the access point has been prevalently used.

Institute of Electrical and Electronics Engineers (IEEE) 802 that is standards organization of WLAN technology established on February 1980 has performed many standard works. At the early stage, the WLAN technology supports a rate of 1 to 2 Mbps by frequency hopping using 2.4 GHz frequency, spread spectrum, infrared communication, or the like, based on IEEE 802.11. Recently, the WLAN technology can support a rate of a maximum of 54 Mbps based on IEEE 802.11g standard by using orthogonal frequency division multiplex (OFDM). In addition, IEEE 802.11 has practically used or developed standards of various technologies such as enhancement of quality for service (QoS), compatibility of access point (AP) protocol, security enhancement, radio resource measurement, wireless access vehicular environment, wireless access vehicular environment, fast roaming, mesh network, interworking with external network, wireless network management, or the like. Further, in order to overcome a limitation of communication rate indicated as vulnerability in the WLAN, there is IEEE 802.11n as a technology standard recently established. An object of the IEEE 802.11n is to extend a speed and reliability of a network and extend an operating distance of the wireless network. More specifically, the IEEE 802.11n is based on multiple inputs and multiple outputs (MIMO) technology in which multiple antennas are used at both of a transmitting end and a receiving end in order to support a high throughput (HT) having a maximum data processing speed of 600 Mbps or more, minimize a transmission error, and optimize a data speed. In addition, the standard may use a coding scheme several duplicated copies in order to increase data reliability and may also use the orthogonal frequency division multiplex (OFDM) so as to increase a rate.

A station (STA) configuring the WLAN system accesses a channel for data transmission. The channel is used to transmit between the STAs or between the AP and the STA and is a wireless medium to which a specific frequency band is assigned. A channel access method of the WLAN system is based on a contention based access scheme and therefore, other APs and STAs cannot access the channels occupied in advance. Therefore, in order for the AP and the STA to access the channel, the AP and the STA access the channel through the contention process. Further, the WLAN system is an example of the wireless communication and therefore, the frame transmission and reception through the specific channel may be interfered by a homogenous communication procedure or a heterogeneous communication procedure through different adjacent channels Therefore, a need exists for an improved WLAN system and a communication method using the same capable of increasing efficiency of wireless resources in a limited channel environment while mitigating interference occurring during the exchange of frames.

### SUMMARY OF THE INVENTION

The present invention provides an improved WLAN access point system and a frame transmitting and receiving method using the same capable of supporting a multiple channel access based on a virtual access point (VAP) service protocol to which different channels are assigned.

In an aspect, a wireless local area network (WLAN) access point (AP) system is provided. The WLAN AP system includes a first virtual access point (VAP) that is logical entity performing communication with a first station (STA); and a second VAP performing communication with a second STA. The first VAP uses a first channel to exchange a frame with the first STA and the second VAP uses a second channel to exchange a frame with the second STA.

A frequency band of the first channel and a frequency band of the second channel may not be adjacent to each other.

The frame exchange through the first channel and the frame exchange through the second channel may be performed for different time periods.

Identification information of a first basic service set (BSS) based on the first VAP and identification information of a second BSS based on the second VAP may be different from each other.

The first channel and the second channel may be each occupied simultaneously.

In another aspect, a method for transmitting a data frame performed by an AP in a WLAN system is provided. The method includes associating with a first STA; associating with a second STA; transmitting a first data frame to the first STA using a first channel; and transmitting the first data frame to the second STA using a second channel after transmitting the data frame to the first STA.

The AP may include a first VAP and a second VAP independently performing communication with the STA. The first STA may be associated with the first VAP and the second STA may be associated with the second VAP.

A frequency band of the first channel and a frequency band of the second channel may not be adjacent to each other.

The method may further include receiving a first acknowledgement frame (ACK frame) transmitted from the first STA corresponding to the first data frame.

The method may further include receiving a second ACK frame transmitted from the second STA corresponding to the second data frame.

The associating with the first STA may include transmitting the identification information of the first BSS based on the first VAP to the first STA.

The associating with the second STA may include transmitting the identification information of the second BSS based on the second VAP to the second STA.

In still another aspect, an access point is provided. The access point includes a transceiver transmitting and receiving radio signals and a processor operably coupled to the transceiver and configured for: associating with a first STA; associating with a second STA; transmitting a first data frame to the first STA using a first channel; and transmitting the first data frame to the second STA using a second channel after transmitting the data frame to the first STA.

The processor may be configured for implementing a first VAP and a second VAP that are logical entities independently communicating with the STA. The first STA may be associated with the first VAP and the second STA is associated with the second VAP.

A frequency band of the first channel and a frequency band of the second channel may not be adjacent to each other.

### BRIEF DESCRIPTION OF THE DRAWINGS

FIG. 1 is a diagram showing an example of a configuration of a WLAN system.

FIG. 2 is a diagram showing an infrastructure BSS configuring the WLAN system.

FIG. 3 is a diagram showing an example of a configuration of the WLAN system.

FIG. 4 is a diagram showing an example of a channel use according to an exemplary embodiment of the present invention.

FIG. 5 is a diagram showing a structure of a virtual AP according to the embodiment of the present invention.

FIG. 6 is a flow chart showing a procedure of providing a WLAN service according to the exemplary embodiment of the present invention.

FIG. 7 is a diagram showing a use example of a WLAN channel used by the WLAN system and a Zigbee wireless communication system.

FIG. 8 is a diagram showing a frame exchange environment of the WLAN according to the exemplary embodiment of the present invention.

FIG. 9 is a block diagram showing a wireless device in which the exemplary embodiment of the present invention may be implemented.

### DESCRIPTION OF EXEMPLARY EMBODIMENTS

Hereinafter, exemplary embodiments of the present invention will be described in detail with reference to the accompanying drawings so that those skilled in the art may easily practice the present invention. However, the present invention may be modified in various different ways and is not limited to the exemplary embodiments provided in the present description. In the accompanying drawings, portions unrelated to the description will be omitted in order to obviously describe the present invention, and similar reference numerals will be used to describe similar portions throughout the present specification.

Unless explicitly described to the contrary, the term “comprise” and variations such as “comprises” or “comprising” will be understood to imply the inclusion of stated elements but not the exclusion of any other elements. A term “module” described in the specification means a single unit of processing a predetermined function or operation and can be implemented by hardware or software or a combination of hardware and software.

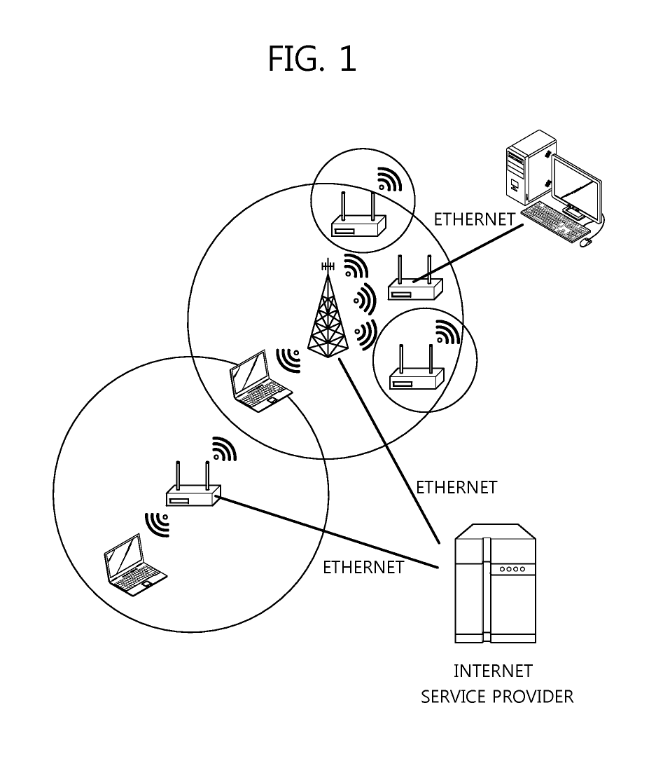

FIG. 1 is a diagram showing an example of a configuration of a wireless local area network (WLAN) system.

Referring to FIG. 1, the WLAN system is basically based on a local area network (LAN) by an internet service provider. The LAN service by the internet service provider may be based on a communication protocol known as Ethernet.

The WLAN system may be managed by a wireless router and/or a wireless backhaul that is connected with the Internet service provider and the Ethernet, thereby providing the WLAN service. Wireless devices configuring the WLAN system are managed by the wireless router and/or the wireless backhaul, thereby transmitting and receiving a frame. The wireless router is connected with the wireless backhaul, thereby providing services.

The WLAN system includes one or more basic service set (BSS). The BSS is a set of STAs that may be successfully synchronized to communicate with each other and thus, does not include a concept indicating a specific region.

The BSS includes a concept of an infrastructure BSS and an independent BSS (IBSS).

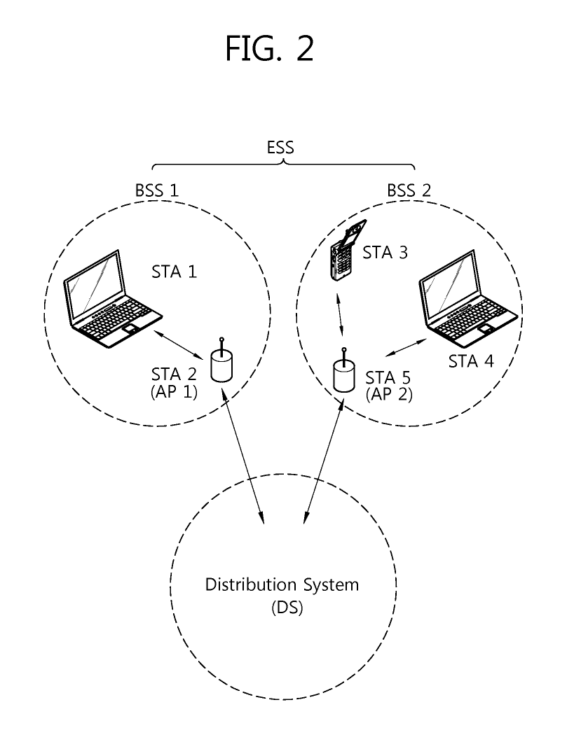

FIG. 2 is a diagram showing the infrastructure BSS configuring the WLAN system.

The infrastructure BSSs (BSS1 and BSS2) include more than one STAs (STA1, STA3, and STA4), an access point (AP) that is the STA providing a distribution service, and a distribution system (DS) connecting a plurality of APs (AP1 and AP2). On the other hand, since the IBSS does not include the AP, all the STAs are configured of a mobile station and do not access the DS and thus, forms a self-contained network.

The STA includes a medium access control (MAC) according to IEEE 802.11 standard and includes both of the AP and non-AP station, in a broad sense, as any function medium including a physical layer interface for a wireless medium. Further, the STA including a transceiver operated at 60 GHz is referred to as a mmWave STA (mSTA).

The STA for wireless communication may include a processor and a transceiver and may include a user interface unit, a display unit, or the like. The processor, which is a function unit devised to generate the frame to be transmitted through the wireless network or process the frame received through the wireless network, serves to several functions for controlling the STA. Further, the transceiver is a unit that is functionally connected with the processor and transmits and receives the frame through the wireless network for the station.

The portable terminal operated by the user among the STAs, which is a non-AP STA, is referred to as the non-AP STA when being simply referred to STA hereinafter. The Non-AP STA may be referred to as other names such as a terminal, a wireless transmit/receive unit (WTRU), a user equipment (UE), a mobile station (MS), a mobile terminal, a wireless device, a mobile subscriber unit, or the like.

The AP is a functional entity that provides an access to DS via a wireless medium for the STA associated therewith. In the infrastructure BSS including the AP, communication among the STAs may be basically performed via the AP, but may be directly performed among the STAs when direct links are established. The AP may be referred to as the access point but may also be referred to as a centralized controller, a base station (BS), a node-B, base transceiver system (BTS), or a site controller, or the like. As shown in FIG. 1, the AP simply includes a wireless router and a wireless bridge for providing the WLAN services as well as a wireless backhaul device/functional entity sharing with another network through wireless communication.

In the WLAN system, the AP and/or STA is based on the wireless resources for transmitting frames, that is, carrier sensing multiple access-collision avoidance (CSMA-CA) protocol at the time of using the channel. When the specific AP and/or the STA occupy the wireless resources, other terminals therearound cannot access the channels and thus, cannot use the channels. In this condition, the AP and/or the STA can access the channel based on the contention based access service so as to occupy the channel for transmitting the frame. A detailed specification related with the channel access of the AP and/or the STA may be referred to section 9 of ‘IEEE Standard for Information technology—Telecommunications and information exchange between systems—Local and metropolitan area networks—Specific requirements, Part 11 Wireless LAN Medium Access Control(MAC) and Physical Layer(PHY) Specifications’.

Meanwhile, a stand-alone AP, which is an AP providing the WLAN service, corresponds to a train, a subway, or a case in which a large-scale WLAN is centrally managed. The stand-alone AP means that the wireless devices within the AP wireless communication service coverage perform the wireless communication through the single AP. In this case, an inter-channel interference problem that is a weakness of the WLAN can be easily solved. The inter-channel interference is multiple user interference using the same frequency or two adjacent channels, such that signals of other users acts as interference or noise for the signal of the user, except for the signal of the user at the AP using a specific frequency.

At the current stand-alone AP, a channel bandwidth supporting the wireless communication services is 20 MHz. On the other hand, the user of the wireless devices supporting the WLAN in addition to a smart phone is increased and as a result, the data traffic has been very rapidly increased. This may cause overload and bottle phenomenon to the WLAN system managed by the stand-along AP. To solve the problem, a channel bonding technology providing services by grouping two adjacent channel to increase a bandwidth twice has been used. The AP using the channel bonding technology is rarely used. Even though the wireless communication service is provided via the AP, the transmission rate of a medium access control layer (MAC) or a user layer of the AP does not exceed twice.

Further, the AP providing the WLAN system service uses an industrial scientific medical (ISM) band that does not require a license permission. In Korea, 13 channels may be used at a frequency of 2.4 GH band and a total of 83.5 MHz band is assigned at 2.4 to 2.4835 GHz. In the case of the frequency of 5 GHz band, a total of 480 MHz is assigned at 5.15˜5.35, 5.470˜5.650, 5.725˜5.825 GHz.

In order to provide the wireless communication service, the AP provides services via a single channel among 13 channels and assigns 200 MHz as the channel bandwidth thereto.

In the case of the wireless LAN system managed by the stand-alone AP, the frequency bandwidth actually used among a total of 83.5 MHz bandwidth is a bandwidth of 20 MHz, thereby significantly degrading the frequency use efficiency. In the WLAN system including the plurality of APs, in order to avoid co-channel interference and adjacent channel interference, the channel space is emptied but the AP like a train or a subway may not be arbitrarily mounted and centrally managed and may be inefficient at a place where data flooding of a user is predicted.

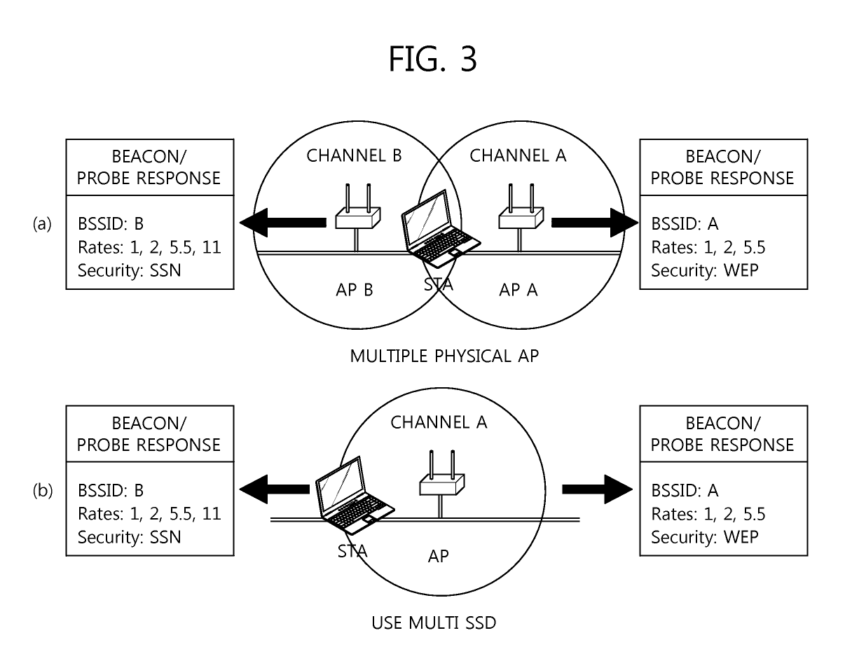

Therefore, in order to solve the above-mentioned problem, a concept of a virtual AP may be introduced. The WLAN system into which the virtual AP is introduced will be below described with reference to FIG. 3.

FIG. 3 is a diagram showing an example of a configuration of a WLAN system. FIG. 3A is a WLAN system in which the plurality of APs provides the WLAN services. FIG. 3B is a WLAN system in which the AP to which the virtual AP is applied provides the WLAN services.

Referring to FIG. 3A, the two APs physically divided configure the WLAN system. The two APs use the co-channel, but configure each BSS and uses different BSSID and difference WLAN capabilities. Each AP broadcasts a beacon frame and/or a probe response frame including different control information to the STAs therearound. Further, each AP provides independently WLAN services and transmits and receives the data frame to and from the STA.

Referring to FIG. 3B, the WLAN system is physically configured by a single AP. However, the AP provides the WLAN services using a multiple SSID scheme. Thereby, the AP broadcasts a beacon frame and/or a frame response frame including different control information such as different BSSIDs, WLAN capabilities, or the like, to the STAs therearound.

As shown in FIG. 3B, when the WLAN system is built, this can exert the same effect as the case in which the plurality of APs are installed. However, two APs share the co-channel and therefore, correspond to the case in which the network is separated simply. However, the AP actually accesses only one channel and therefore, the performance of the AP may be degraded even when the multi SSID is implemented. Therefore, the present invention may allow the virtual AP1 and the virtual AP2 configuring the AP to use different channels.

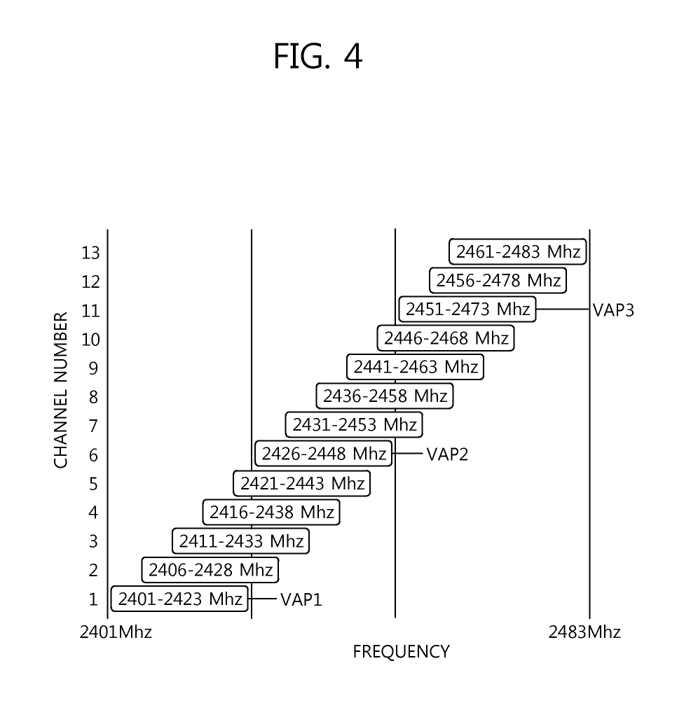

FIG. 4 is a diagram showing an example of a channel use according to an exemplary embodiment of the present invention.

It can be appreciated from referring to FIG. 4 that 13 channels from channel 1 to channel 13 are assigned as an available channel for the WLAN system.

In this case, each virtual AP configuring the AP is set to use different channels. As an example, in the AP, the first virtual AP may be set to use channel 1, the second virtual AP may be set to use channel 6, and the third virtual AP may be set to use channel 11. That is, exchanging the frame between the first virtual AP and the STA via channel 1 may be considered as exchanging the frame between the stand-alone AP and the STA using channel 1 that is the actual physical channel. In this case, channel 6 and channel 11 may be referred to as the virtual channel or the reserved channel.

In this case, the frequency band of the channels assigned to each virtual AP may be set to bands that are not adjacent to each other. This prevents the interference due to the used of the adjacent frequency band to each other, thereby improving the reliability of the WLAN system.

The channels shown in FIG. 4 are a channel implemented in a 2.4 GHz band, but are only by way of example. The channel at a 5 GHz band or different frequency bands may be implemented. In addition, the first channel may be assigned with one channel in a 2.4 GHz band, the second channel may be assigned with one channel among a 5 GHz band, the third channel may be assigned with one channel implemented in the third frequency band, and the first, second, and third channel allocations are not limited to the specific frequency band.

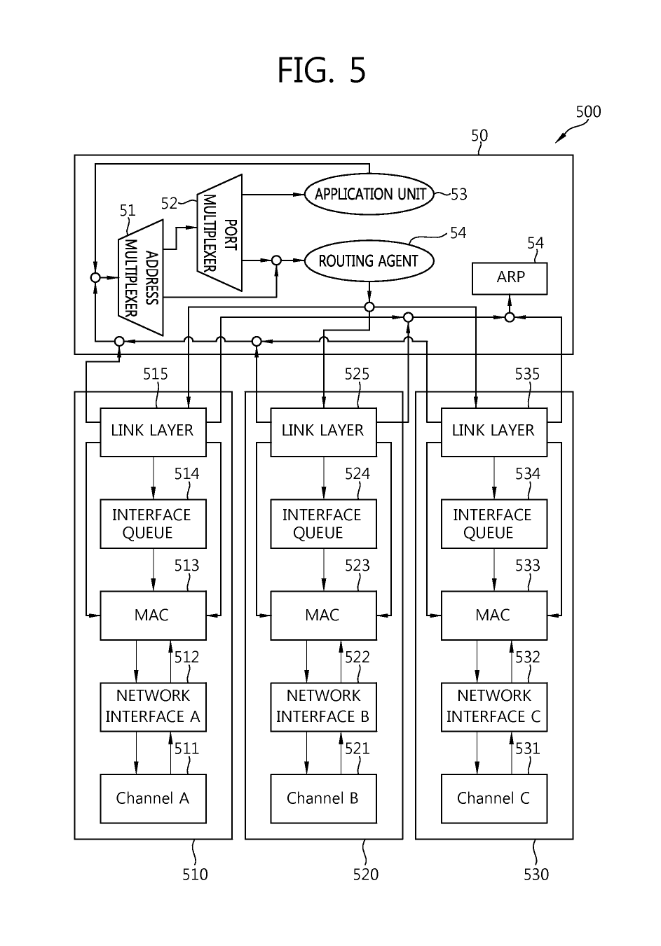

FIG. 5 is a diagram showing a structure of a virtual AP according to the embodiment of the present invention.

Referring to FIG. 5, a single physical AP 500 includes a plurality of virtual APs 510, 520, and 530. The plurality of virtual APs 510, 520, and 530 are not network entity that is not present in actual and is logical entity that demodulates and decodes wireless signals transmitted through different channels and transmits the wireless signals to an upper layer.

In each virtual AP 510, 520, and 530, the physical layer (PHY) and the data link layer are differently virtualized and the upper layer above there is commonly operated.

The physical layer of the first virtual AP 510 includes a channel A 511 and a network interface A 512 for transmitting and receiving the frames through the channel A 511. Channel A 511 means the wireless frequency resource of the specific band transmitted and received by the virtual AP 510 and the network interface A 512 is an interface which may be applied for wireless transmission and reception through channel A, which performs a procedure of generating an MAC frame transmitted at a medium access control (MAC) layer as a wireless signal. For example, the interface A 512 may be set to perform a modulation/demodulation scheme, a coding scheme, or the like, that meets channel characteristics.

The data link layer of the first virtual AP 510 includes an MAC 513, an interface queue 514, and a link layer 515. The MAC 513 performs framing so that data to be transmitted to the STA may be transmitted through the physical layer and acquires data by decomposing the data unit transmitted through the physical layer. Further, contending for accessing the wireless medium on the WLAN system based on the contending accessing system is performed. The link layer 515 serves to connect the upper layer 50 commonly operated by the virtual APs with the data link layer.

The second virtual AP (520) and the third virtual AP (530) are each implemented to include a logical entity like the first virtual AP 510. That is, the second virtual AP 520 includes a physical layer including channel B 521, a network interface B 522 and a data link layer including an MAC 523, an interface queue 524, and a link layer 525 and the third virtual AP 530 includes channel C 531, a physical layer including a network interface C 532, and a data link layer including an MAC 533, an interface queue 534, and a link layer 535.

The upper layer 50 includes an address multiplexer 51, a port multiplexer 52, an application unit 53, a routing agent 54, and an address resolution protocol (ARP) 55. The upper layer 50 processes data or information transmitted from each virtual AP 510, 520, and 530. In addition, each virtual AP 510, 520, and 530 may sequentially access a channel to schedule a WLAN service.

When any frequency band is assigned to channel A among the whole frequency band assigned to the AP, one other than the assigned frequency band is assigned to the other virtual APs. A frequency policy may be set so that the same frequency and the adjacent frequency are not generated.

Each virtual AP may also support a multi SSID function to which different SSIDs are given.

A procedure of allowing each virtual AP to provide the WLAN services is the same as a procedure of allowing the existing AP to provide services. The STA may access each channel while seeing the SSID transmitted from the AP.

The stand-alone AP in which the virtual APs are implemented may select one of each AP multiple access scheme to provide the WLAN services. For example, when the TDMA scheme is applied, the first virtual AP to which channel A is assigned according to the scheduling first starts the WLAN services and ends. Thereafter, the virtual AP may be set to start the WLAN services.

Each virtual AP may allow the inherent capabilities such as a modulation and coding scheme (MCS), a transmission rate, a spreading scheme, an output limiting scheme, or the like, to be independently set. Further, when the stand-alone AP is automatically or manually operated as a single channel, roaming to the channel A can be performed.

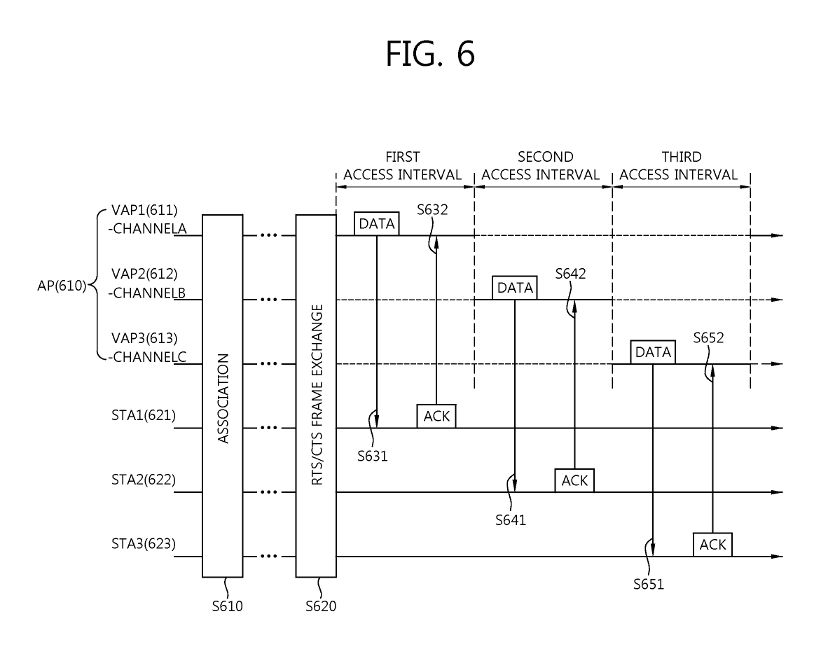

FIG. 6 is a flow chart showing a procedure of providing a wireless local area service according to the exemplary embodiment of the present invention.

Referring to FIG. 6, an AP (610) includes virtual AP1 (VAP1) 611, VAP2 612, and VAP3 613. A plurality of VAPs are set to provide the WLAN services in order of the VAP1 611, the VAP2 612, and the VAP3 613. The VAP1 611, the VAP2 612, and the VAP3 613 may each be set to provide the WLAN services by using channel A, channel B, and channel C, respectively.

STA1 621, STA2 622, and STA3 623 are associated with the AP 610 (S610). Although the drawing shows that the STAs are simultaneously associated with the APs, each STA may be associated with the AP through the independent procedure.

The AP 610 may the STAs with the specific VAP through the association process (S610). The STA1 621 may be associated with the VAP1 611, the STA2 622 may be associated with the VAP2 612, and the STA3 623 may be associated with the VAP3 613.

The control information on the BSS1 managed by the VAP1 611, the control information on the BSS2 managed by the VAP2 612, and the control information on the BSS3 managed by the VAP3 613 may be transmitted through the association process. The control information transmitted by the AP includes the information on the accessible channel and the data rate of the BSS, modulation and coding scheme (MCS), or the like, that are managed by each VAP. In addition, an order of accessing the plurality of VAPs to the channel and the information related to an access interval if necessary may be transmitted.

The AP 610 acquires a channel access right through the exchange between the STAs and the RTS/CTS frame exchange (S620). The AP 610 may acquire the control information required to transmit and receive the frame through the exchange of the RTS/CTS frame.

The VAP1 611 may first access the channel to provide the WLAN services. The VAP1 611 accesses channel A and transmits the data frame to the STA1 621 (S621). The STA1 621 transmits an acknowledgement frame (ACK) as a response for the data frame transmission (S622).

The VAP2 612 accesses channel B to transmit the data frame to the STA2 622 after the first access interval ends by the VAP1 611 (S631). The STA2 622 transmits ACK as the response for the data frame transmission (S632).

Unlike the first access interval and the second access interval, the STA3 613 first accesses channel C at the third access interval and may transmit the data frame to the VAP3 613 (S641). The VAP3 (613) transmits the ACK as the response for the data frame to the STA3 623 (S642).

When the third access interval ends, the VAP1 611 may again access the channel A to provide the WLAN services.

In addition, when different types of wireless communication systems using a frequency band like the WLAN system are present, there may be a problem in using the frequency band by two types of communication systems.

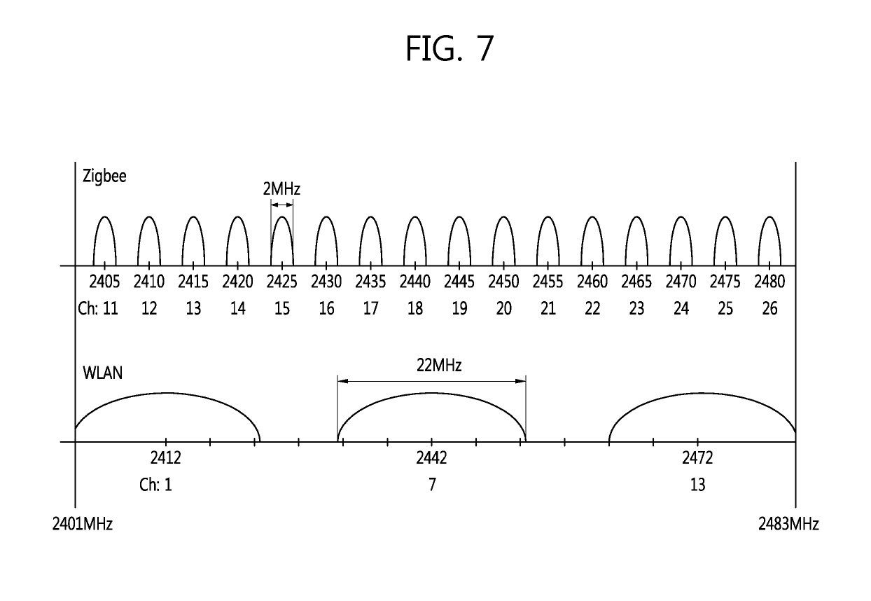

FIG. 7 is a diagram showing a use example of a WLAN channel used by the WLAN system and a Zigbee wireless communication system. The WLAN system using a 2.4 GHz band will be described by way of example.

Referring to FIG. 7, the Zigbee wireless communication system based on the IEEE 802. 15.4 standard uses a frequency band of 2.4 GHz like the WLAN system. The Zigbee system performs communication using a channel of 2 MHz bandwidth.

Meanwhile, when the WLAN system uses channel 1, the adjacent Zigbee wireless communication systems cannot use channels 11, 12, 13, and 14. Similarly, when the WLAN system uses channel 7, the adjacent Zigbee wireless communication system cannot use channels 17, 18, 19, and 20 and when the WLAN system uses channel 13, the adjacent Zigbee wireless communication system cannot use channel 23, 24, 25, and 26.

In this condition, the WLAN system using the assigned one channel cannot perform communication by shifting the channel in response to the communication condition of the heterogeneous wireless communication system that is being operated in the adjacent frequency band, but the WLAN system based on the virtual AP according to the exemplary embodiment of the present invention may operate the wireless communication through the channel that does not overlap the channel being operated by the heterogeneous wireless communication system.

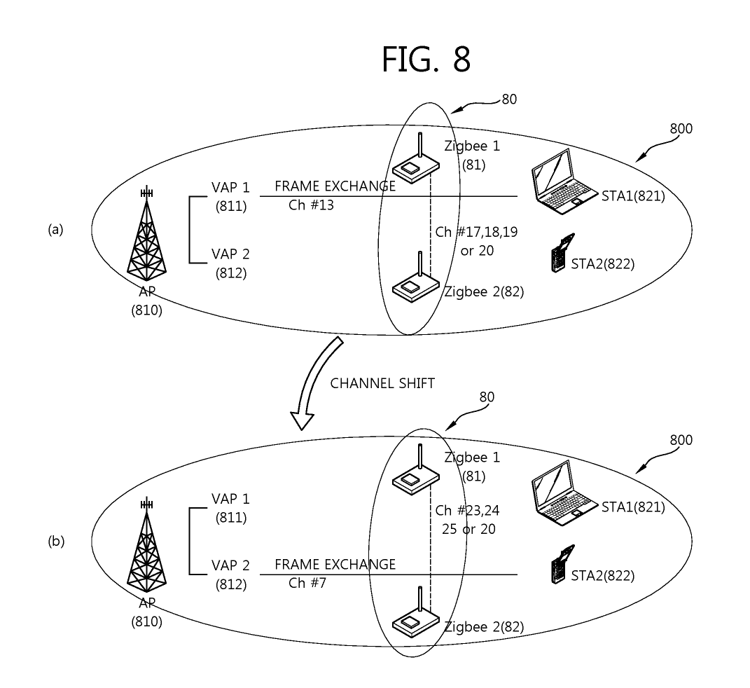

FIG. 8 is a diagram showing a frame exchange environment of the WLAN according to the exemplary embodiment of the present invention.

Referring to FIG. 8, an AP 800 configuring a WLAN system 800 includes a VAP1 811 and a VAP2 812. The VAP1 811 may exchange the frame with a first STA 821 through channel 13 and the VAP2 812 may exchange the frame with a second STA 822 through channel 7.

A Zigbee wireless communication system 80 is adjacently present to the WLAN system 800 and the wireless communication is performed between a Zigbee 1 81 and Zigbee 2 82.

Referring to FIG. 8A, when the Zigbee wireless communication system 80 exchange the wireless signal through channels 17, 18, 19, and 20, the WLAN system 800 may exchange the frame with the STA using channel 13. In this case, the VAP1 811 assigned to which channel 13 is assigned may exchange the frame with the STA1 821.

As described above, the WLAN system based on the VAP shifts the channel by a TDMA scheme to perform the frame exchange. That is, the VAP performing the frame exchange for each time can be changed. That is, as shown in FIG. 8B, the VAP 812 may use channel 7 to perform the frame exchange with the STA2 822. In this case, the Zigbee wireless communication system 80 may use one of channels 23, 24, 25, and 26 to perform the wireless communication.

When the single channel is assigned to the WLAN system, the communication system according to the related art cannot perform the channel shifting (or, frequency shifting) even when the small output device in addition to the WLAN such as the Zigbee uses the same frequency band, but the WLAN system based on the VAP can use the plurality of channels by each VAP and can exchange the frame through the channels, thereby implementing the indirect interference avoidance for other communication schemes. This can improve the reliability of the WLAN system.

Further, the WLAN system can exchange the STA with the frame when using another channel with the passage of time, rather than in a standby state until the channel enters an idle state due to the channel occupancy of the heterogeneous communication system, thereby improving the throughput of the WLAN system.

In the exemplary embodiment of the present invention shown in FIGS. 4 and 8, the number of VAPs implemented through a single physical AP is by way of example only and the number thereof is not limited thereto. Further, there is no restriction that the channels assigned to the plurality of VAPs are to be assigned to the channel implemented in the specific frequency band. Each channel may be assigned as the channel implemented in 2.4 GHz and 5 GHz bands or may be assigned as the specific channel implemented in different frequency bands.

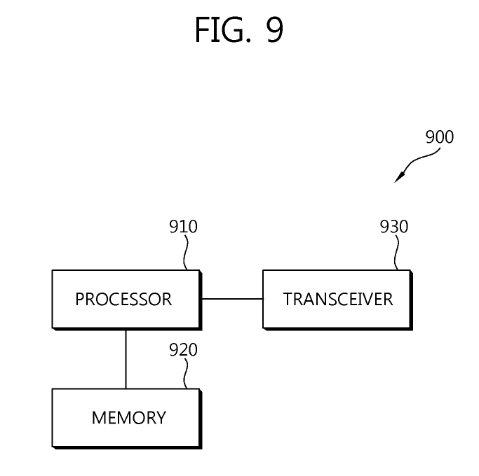

FIG. 9 is a block diagram showing a wireless device in which the exemplary embodiment of the present invention may be implemented. The wireless device as shown in FIG. 9 may be included in the APs and the STAs supporting the VAPs in the exemplary embodiment of the present invention.

Referring to FIG. 9, a wireless device 900 includes a processor 910, a memory 920, and a transceiver 930. The transceiver 930 transmits and/or receives the wireless signal but implements the physical layer of IEEE 802.11. The processor 910 is functionally connected with a transceiver 930 and may be set to implement the exemplary embodiment of the present invention shown in FIGS. 2 to 8.

The processor 910 and/or the transceiver 930 may include an application-specific integrated circuit (ASIC), other chipsets, logical circuits, and/or data processing devices. When the exemplary embodiments of the present invention are implemented by software, the above-mentioned methods may be implemented by a module (process, function, or the like) performing the above-mentioned functions. The module is stored in the memory 920 and may be executed by the processor 910. The memory 920 may be included inside the processor 910 and may be separately disposed outside the processor and be functionally connected to the processor 910 by widely known various units.

According to the exemplary embodiments of the present invention, a stand-alone AP implementing a virtual AP of multiple channel environments between an AP and a STA or between STAs can provide a channel access service capable of increasing efficiency of interference between the STAs and wireless resources and improving reliability and overall throughput of a WLAN system.

In addition, in the case of different types of wireless communication devices using the same frequency band, when a single channel is assigned to the WLAN AP like the existing case, channel shifting (or frequency shifting) cannot be performed even when a small output device other than the WLAN uses the same frequency band. However, the exemplary embodiments of the present invention can use a plurality of channels, thereby avoiding the indirect interference with other communication schemes.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. The exemplary embodiments should be understooed to be only technical ideas rather than to be limited thereto. Therefore, the scope of the present invention is not limited to the specific embodiments but is determeind by the scope of the invention. Accordingly, such modifications, additions and substitutions should also be understood to fall within the scope of the present invention.

What is claimed is:

1. A wireless local area network (WLAN) access point (AP) system comprising:
a first virtual access point (VAP) that is logical entity performing communication with a first station (STA); and
a second VAP performing communication with a second STA,
wherein the first VAP uses a first channel to exchange a frame with the first STA, and
the second VAP uses a second channel to exchange a frame with the second STA.

2. The WLAN AP system of claim 1, wherein a frequency band of the first channel and a frequency band of the second channel are not adjacent to each other.

3. The WLAN AP system of claim 2, wherein the frame exchange through the first channel and the frame exchange through the second channel are performed for different time periods.

4. The WLAN AP system of claim 3, wherein identification information of a first basic service set (BSS) based on the first VAP and identification information of a second BSS based on the second VAP are different from each other.

5. The WLAN AP system of claim 1, wherein the first channel and the second channel are each occupied simultaneously.

6. A method for transmitting a data frame performed by an AP in a WLAN system, the method comprising:
associating with a first STA;
associating with a second STA;
transmitting a first data frame to the first STA using a first channel; and
transmitting the first data frame to the second STA using a second channel after transmitting the data frame to the first STA.

7. The method of claim 6, wherein the AP includes a first VAP and a second VAP independently performing communication with the STA, the first STA is associated with the first VAP, and the second STA is associated with the second VAP.

8. The method of claim 7, wherein a frequency band of the first channel and a frequency band of the second channel are not adjacent to each other.

9. The method of claim 8, further comprising receiving a first acknowledgement frame (ACK frame) transmitted from the first STA corresponding to the first data frame.

10. The method of claim 9, further comprising receiving a second ACK frame transmitted from the second STA corresponding to the second data frame.

11. The method of claim 7, wherein the associating with the first STA includes transmitting the identification information of the first BSS based on the first VAP to the first STA.

12. The method of claim 11, wherein the associating with the second STA includes transmitting the identification information of the second BSS based on the second VAP to the second STA.

13. An access point, comprising:
a transceiver transmitting and receiving radio signals; and
a processor operably coupled to the transceiver and configured for:
associating with a first STA;
associating with a second STA;
transmitting a first data frame to the first STA using a first channel; and
transmitting the first data frame to the second STA using a second channel after transmitting the data frame to the first STA.

14. The access point of claim 13, wherein the processor is configured for:
implementing a first VAP and a second VAP that are logical entities independently communicating with the STA,
wherein the first STA is associated with the first VAP and the second STA is associated with the second VAP.

15. The access point of claim 14, wherein a frequency band of the first channel and a frequency band of the second channel are not adjacent to each other.
